(19) United States
(12) Patent Application Publication
(10) Pub. No.: US 2002/0167948 A1
(43) Pub. Date: Nov. 14, 2002

(54) Communications methods, apparatus, computer program products and data structures using segment sequence numbers

(76) Inventor: Dayong Chen, Cary, NC (US)

Correspondence Address: MYERS BIGEL SIBLEY & SAJOVEC, PO BOX 37428, RALEIGH, NC, 27627, US

(21) Appl. No.: 09/851,621

(22) Filed: May 9, 2001

(51) Int. Cl. H04L 12/28

(52) U.S. Cl. 370/392; 370/394; 370/252

(57) ABSTRACT

An entity of a communications system transmits a segment conforming to a segment format comprising a data portion and a header portion. The header portion includes a field for a sequence number associated with data in the data portion, e.g., a sequence number of byte of data in the data portion. The transmitted segment also includes a segment transmission sequence number. A receiving entity receives the segment and transmits an acknowledgment reflecting the segment transmission sequence number. Responsive to receipt of such an acknowledgment, roundtrip time may be determined. Retransmission timing, e.g., a retransmission timeout (RTO) value, may be adjusted responsive to the determined round trip time.

### BACKGROUND OF THE INVENTION

The present invention relates to communications methods, apparatus, computer program products and data structures, and more particularly, to protocol-constrained communications methods, apparatus, computer program products and data structures.

Communications systems, such as wireless networks, computer networks, telephony networks, and the like, commonly communicate information according to layered procedures, commonly referred to as protocol stacks or suites. Protocols of a protocol stack typically provide such functions as routing, error correction coding, and retransmission. A protocol suite used extensively in the Internet and other communications networks includes an application layer protocol (e.g., TELNET, FTP, SMTP), a transport protocol (e.g., TCP, UDP), an internetworking protocol (e.g., IP), and a network interface hardware protocol (e.g., ethernet, X.25, ATM, SNA).

Transmission Control Protocol (TCP) is a connection-oriented protocol that includes reliability-enhancing features. From an application's viewpoint, a TCP layer can provide transfer of a contiguous stream of bytes from the application. In particular, a sending TCP entity groups bytes received from an application into TCP segments, which are then passed on to an internetworking layer (e.g. an IP layer) for transmission to a destination. The sending TCP entity assigns sequence numbers to each byte transmitted, with the sequence numbers being used to order received data at a receiving TCP entity. TCP is described in detail in TCP/IP Tutorial and Technical Overview, by Murphy et al., published by International Business Machines Corporation (5^{th} ed., 189, 1996), pp. 2-92 through 2-104.

TCP may be viewed as a byte-oriented protocol. In particular, each byte received by a TCP entity is conceptually assigned a 32-bit sequence number. The header portion of each segment transmitted by the entity includes a Sequence Number field which includes the sequence number of a particular byte in the data portion of the segment. The header portion also includes an Acknowledgment Number field, which carries the byte sequence number that the sender expects to receive next. The acknowledgment provided by the Acknowledgment Number field is cumulative, i.e., the sequence number in the Acknowledgment Number field implicitly acknowledges bytes having smaller sequence numbers.

TCP may be vulnerable to a phenomenon known as retransmission ambiguity. For example, if a first segment transmitted by a sending TCP entity fails to be acknowledged by a receiving TCP entity within a predetermined retransmission timeout (RTO), the sending TCP entity retransmits the data of the first segment in a second segment. Assuming that the sending TCP entity receives an acknowledging segment in response to this second segment, the sending TCP entity may have no way of knowing whether the acknowledging segment was transmitted in response to the first segment or the second segment.

TCP employs an adaptive retransmission scheme in which the RTO is adjusted responsive to round trip time (RTT) measurements. Theoretically, such adaptive retransmission can dramatically improve performance if the RTO is set slightly higher than the current RTT. Several techniques for determining RTO using RTT measurements are conventionally used and, accordingly, accuracy in RTT measurements is generally desirable.

The above-described retransmission ambiguity phenomenon can make it difficult to obtain accurate RTT measurements. According to one technique for determining RTT described in “Improving round-trip time estimates in reliable transport protocols,” by Karn et al., ACM Trans. on Computer Systems, vol. 9, no. 4 (November 1991) and commonly referred to as “Karn's algorithm,” if a TCP entity transmits a segment and receives an ambiguous acknowledgment, its forgoes making an RTT measurement based on the ambiguous acknowledgment. If the frequency of such ambiguous acknowledgments is high, RTT may be only infrequently measured. This may reduce the overall accuracy of RTT measurements generated by this technique, which may, in turn, lead to setting RTO to less than optimal levels.

Another technique for RTT measurements is described in RFC1323, “TCP Extensions for High Performance,” by Jacobsen et al., Network Working Group (1992) (available at http://www.faqs.org/rfcs/rfc1323.html). According to this technique, a sending TCP entity includes a timestamp in the header portion of each transmitted segment, and a receiving TCP entity reflects the timestamp in its acknowledgment. The sending entity can subtract the reflected timestamp from the timestamp corresponding to reception of the acknowledgment to determine RTT.

### SUMMARY OF THE INVENTION

According to embodiments of the present invention, an entity of a communications system transmits a segment conforming to a segment format comprising a data portion and a header portion. The header portion comprises a field for a sequence number associated with data in the data portion, e.g. a sequence number of byte of data in the data portion. The transmitted segment also includes a segment transmission sequence number. A receiving entity receives the segment and constructs an acknowledgment reflecting the segment transmission sequence number of the received segment, such as another segment that includes the segment transmission sequence number of the received segment or other information that reflects the segment transmission sequence number of the received segment. Responsive to receipt of such an acknowledgment, roundtrip time may be determined. Retransmission timing, e.g., a retransmission timeout (RTO) value, may be adjusted responsive to the determined round trip time.

The segment transmission sequence number may be included in a field that is also used for other purposes. For example, in modified TCP embodiments according to the present invention, a segment transmission sequence number may be included in an Urgent Pointer field of the header of a first segment when this field is not needed for an Urgent Pointer value, but may be excluded from a second segment's header when the Urgent Pointer field is needed to signal the presence of urgent data. An entity receiving such first and second segments may use respective different procedures for determining a round trip time responsive to the first and second segments.

The present invention may be embodied as apparatus, methods, computer program products, and communications data structures embodied in physical (e.g., storage and/or propagation) media.

### BRIEF DESCRIPTION OF THE DRAWINGS

FIG. 1 is a schematic diagram illustrating a communications system according to embodiments of the present invention.

FIG. 2 is a flowchart illustrating exemplary operations of entities of a communications system according to embodiments of the present invention.

FIG. 3 is a flowchart illustrating exemplary operations of a communications entity according to embodiments of the present invention.

FIG. 4 illustrates an exemplary segment format according to embodiments of the present invention.

FIG. 5 illustrates exemplary operations of communications entities using a modified TCP segment format according to embodiments of the present invention.

FIG. 6 illustrates a modified TCP segment format according to embodiments of the present invention.

FIG. 7 is a flowchart illustrating exemplary operations of a sending entity using the modified TCP segment format of FIG. 6 according to embodiments of the present invention.

FIG. 8 is a flowchart illustrating exemplary operations of a receiving entity using the modified TCP segment format of FIG. 6 according to embodiments of the present invention.

### DETAILED DESCRIPTION

The present invention now will be described more fully hereinafter with reference to the accompanying drawings, in which typical embodiments of the invention are shown. This invention may, however, be embodied in many different forms and should not be construed as limited to these embodiments; rather, these embodiments are provided so that this disclosure will be thorough and complete, and will fully convey the scope of the invention to those skilled in the art. In the drawings, like numbers refer to like elements throughout.

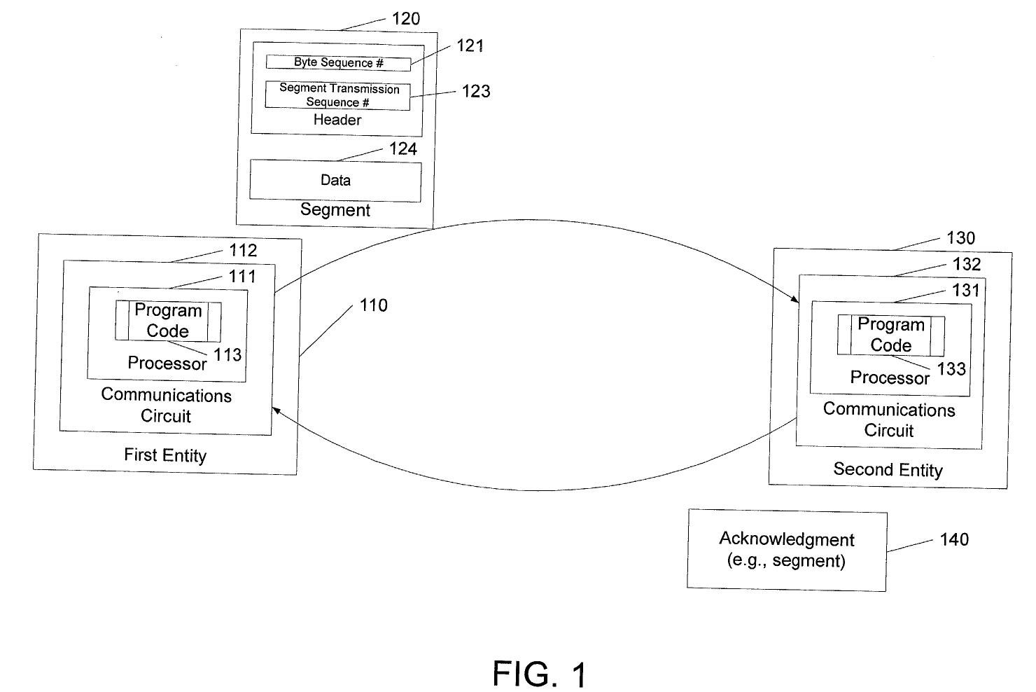

In the present application, FIGS. 1-8 are schematic diagrams and flowcharts illustrating exemplary communications apparatus and operations according to embodiments of the present invention. It will be understood that blocks of the schematic diagrams and flowcharts, and combinations of blocks therein, may be implemented using one or more electronic circuits. It will also be appreciated that, in general, blocks of the schematic diagrams and flowcharts, and combinations of blocks therein, may be implemented in one or more electronic circuits, such as in one or more discrete electronic components, one or more integrated circuits (ICs) and/or one or more application specific integrated circuits (ASICs), as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the operations specified in the block or blocks. The computer program instructions may also be executed on a computer or other data processing apparatus to cause a series of operations to be performed on the computer or other programmable apparatus to produce a computer implemented process such that the instructions which execute on the computer or other programmable apparatus provide operations for implementing the operation specified in the block or blocks.

The present invention may also be embodied in a physical medium, such as storage or signal propagation medium. For example, the present invention may be embodied as a communications data structure or computer-readable program code embodied in a computer readable storage or signal propagation medium for use by or in connection with an instruction execution system or as a communications data structure embodied in a storage or propagation medium. The storage and propagation medium may include, but is not limited to, electronic, magnetic, optical or other storage media. For example, a communications data structure or computer program instructions according to embodiments of the present invention may be embodied in memory included in a communications system and/or in an apparatus and/or storage medium operable to program such memory. Other examples (a non-exhaustive list) of storage and propagation media include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

FIG. 1 illustrates a sending entity 110 and a receiving entity 130 of a communications system according to embodiments of the present invention. The sending entity includes a communications circuit 112 that is operative to transmit a segment 120 (e.g., a TCP segment). The segment 120 conforms to a segment format that includes a header portion 122 and a data portion 124. The header portion 122 includes a field configured to include a sequence number 121 associated with a quantum (e.g., a byte) of data in the data portion 124, along with a field configured to include a segment transmission sequence number 123. The receiving entity 130 includes a communications circuit 132 operative to receive the segment 120 and to responsively generate an acknowledgment 140 that reflects the original segment transmission sequence number 123. For example, the acknowledgment 140 may comprise a segment including the original segment transmission sequence number, as described below, or information that indirectly reflects the original sequence number.

The present invention is applicable to a wide variety of different communications applications. Generally, the sending and receiving entities 110, 130 may comprise wireless, wireline, optical or other communications entities. In particular, the communications circuits 112, 132 may be operative to transmit the segment 120 and the acknowledgment 140, respectively, in a wireless, wireline, optical or other communications medium. Accordingly, it will be appreciated that the present invention is generally applicable to wireless communications, communications over wireline media, such as telephone and computer networks, optical media such as fiber optic lines, and combinations thereof. It will be further appreciated that, although embodiments herein relate to applications using transmission control protocol (TCP), the present invention is also applicable to other protocols.

It will be further appreciated that the communications circuits 112, 132 may be implemented using a number of different types of circuitry, including special purpose circuitry, general purpose data processing circuitry configured to execute program code, and combinations thereof. For example, as shown in FIG. 1, the communications circuits 112, 132 may include processors 111, 131, such as microprocessors, microcontrollers, digital signal processors (DSPs), or other data processing devices, that execute program code 113, 133 operative to perform the communications operations herein.

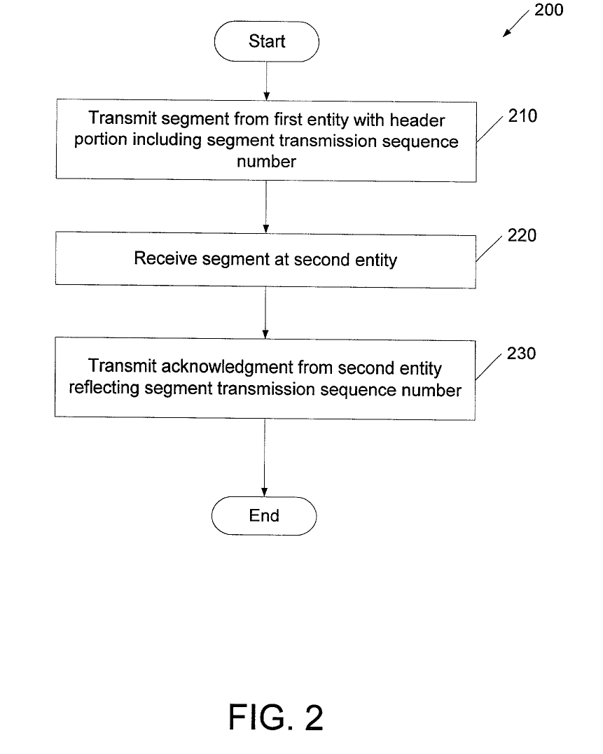

FIG. 2 illustrates exemplary operations 200 of the sending and receiving entities 110, 130 of FIG. 1 according to embodiments of the present invention. A segment including a data portion and a header portion that includes a segment transmission sequence number and a sequence number for data in the data portion is transmitted from the first entity 110 (Block 210). The transmitted segment is received at the second entity 130 (Block 220). In response, the second entity 130 transmits an acknowledgment that reflects the segment transmission sequence number from the received segment (Block 230). For example, the acknowledgment may include the segment transmission sequence number from the received segment or other information that reflects this segment transmission sequence number, such as a next expected segment transmission sequence number.

According embodiments of the present invention, segment transmission sequence numbers as described above may be used to generate estimates of round-trip time (RTT) that may be more accurate than those generated using conventional techniques. These RTT estimates can be used to, among other things, make adjustments to retransmission timing that may improve performance in a communications system.

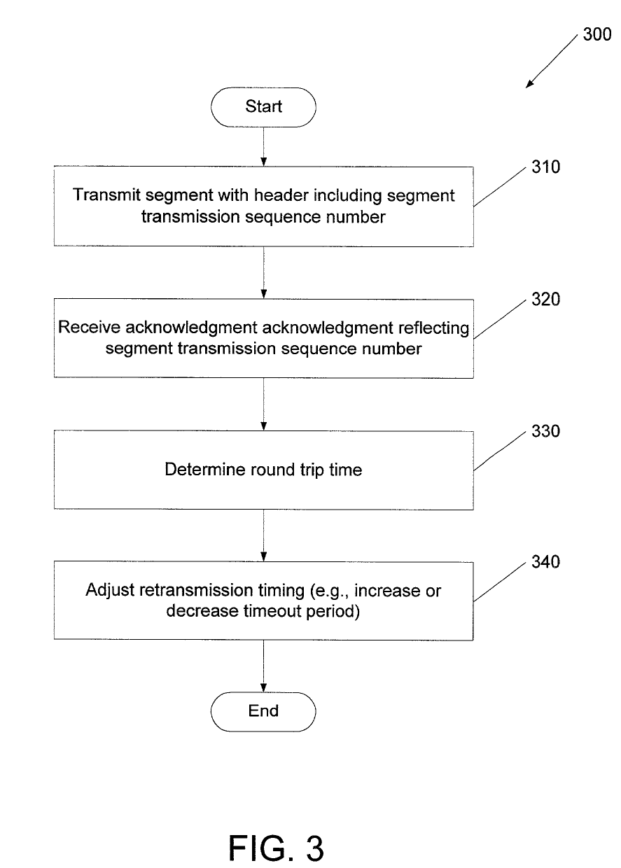

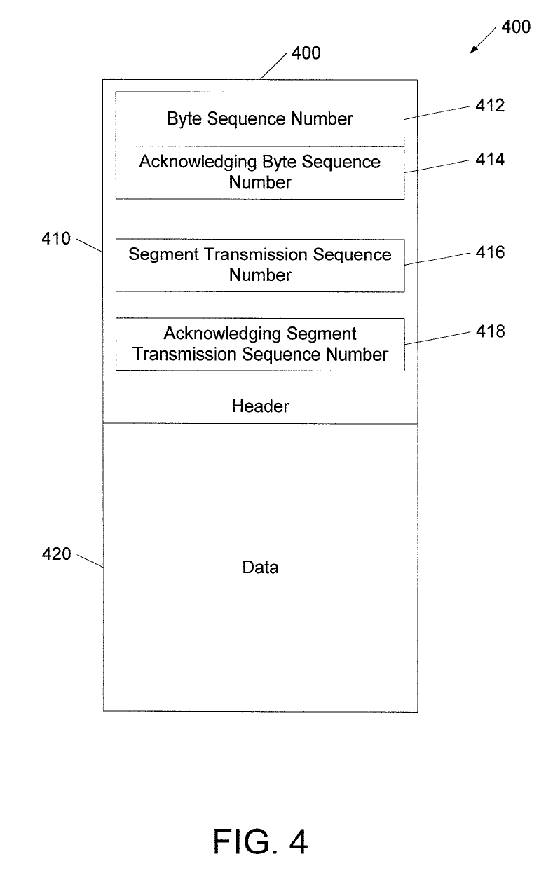

FIG. 3 illustrates exemplary operations 300 for determining a round trip time and adjusting retransmission timing according to embodiments of the present invention. A sending entity, such as the first entity 110 of FIG. 1, transmits a segment with a header that includes a segment transmission sequence number (Block 310). Subsequently, the sending entity receives an acknowledgment reflecting the segment transmission sequence number, e.g., in an acknowledging segment transmitted by a receiving entity, such as the second entity 130 of FIG. 1 (Block 320). Round trip time is then determined responsive to the transmission of the segment and the receipt of the acknowledgment, for example, based on stored time values associated with the sending and receiving events (Block 330). Retransmission timing, (e.g., the retransmission timeout (RTO) value used by the sending entity), is then adjusted based on the determined round trip time (Block 340). According to embodiments of the present invention, a common segment format may be used for both transmitted segments and acknowledgments thereof. A transmitted segment formatted according to this common segment format may include a header portion that includes fields that are configured to include both a segment transmission sequence number for the segment and an acknowledging sequence number. For example, as shown in FIG. 4, a segment format 400 according to embodiments of the present invention includes a header portion 410 and a data portion 420. The header portion 410 includes a field 412 for a sequence number of a byte included in the data portion 420, along with a field 414 for an acknowledging byte sequence number, in keeping with conventional TCP. The header portion 420 further includes a field 416 for a segment transmission sequence number, as well as field 418 for an acknowledging segment transmission sequence number.

Segment transmission sequence numbers, such that the segment transmission sequence numbers for the field 416 of the segment format 400 of FIG. 4, may be maintained in a number of different ways. For example, each entity in a communications system may maintain a segment transmission sequence number state machine that generates sequence numbers for segments that the entity transmits, and which increments or decrements a predetermined amount with each new segment it transmits. When the sequence numbers have incremented or decremented to a predetermined value (e.g., a maximum or minimum), the state machine may be initialized to a predetermined initial value. The entity may also reserve certain sequence number values to signal such conditions as lack of data in the data portion of the segment. For example, such a sequence number state machine may increment by one (1) modulo 255, and may use zero (0) to signal an absence of data or other condition associated with a segment.

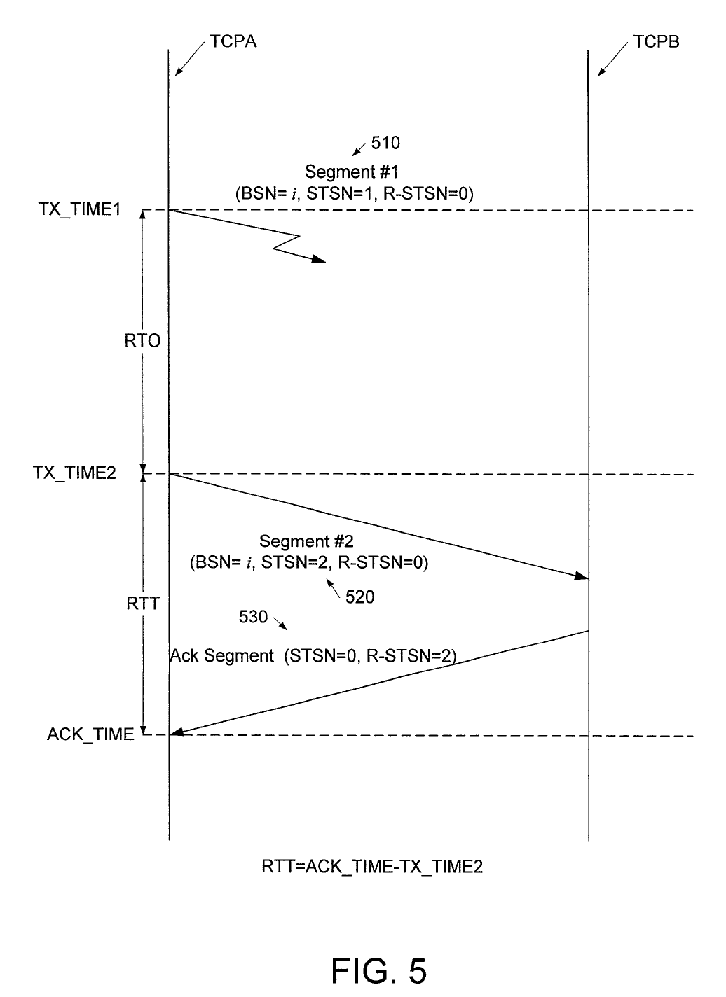

FIG. 5 illustrates exemplary operations using such a technique according to embodiments of the present invention. A first TCP entity TCPA transmits a first segment 510 that is destined for a second TCP entity TCPB, and stores the associated transmission time TX_TIME1 (e.g., in the form of a timestamp). The first segment 510 includes data (not shown) and a byte sequence number (BSN) for a byte i of the data. The first segment 510 also includes a segment transmission sequence number (STSN) that is equal to 1, along with an acknowledgment segment transmission sequence number, here referred to as a reflected segment transmission sequence number (R-STSN), that is equal to 0. In the illustrated case, the R-STSN value is set to zero to indicate that the first segment 510 does not acknowledge any segment previously received at the first TCP entity TCPA.

When the first TCP entity TCPA fails to receive an acknowledgment of the first segment 510 within its current retransmission timeout (RTO), it transmits a second segment 520 that includes the same data as the first segment 510 and the same BSN, and stores the associated transmission time TX_TIME2. However, the second segment includes an incremented STSN value of 2. The second TCP entity TCPB receives the second segment 520, and transmits an acknowledging segment 530 including a R-STSN value of 2 that acknowledges receipt of the second segment 520. As shown, the acknowledging segment 530 has its STSN set to zero, which may be used to indicate that the acknowledging segment 530 does not include any data.

The first TCP entity TCPA receives the acknowledging segment 530 and stores the associated reception time ACK_TIME. The presence of the segment transmission sequence numbers STSN, R-STSN in the received segment 530 allows for an unambiguous measurement of round trip time (RTT), as the first TCP entity TCPA knows that the acknowledging segment 530 refers to the second transmitted segment 520 and not to the first transmitted segment 510, even though the first and second transmitted segments 510, 520 include the same BSN. In particular, RTT can be determined by simply subtracting the stored transmission time TX_TIME2 of the second segment 520 from the reception time ACK_TIME of the acknowledging segment 530.

It will be appreciated that the operations of FIG. 5 may be modified within the scope of the present invention. For example, rather than including an R-STSN value of 2 in the acknowledging segment 530, the acknowledging segment 530 may include an R-STSN value of 3 representing a next expected STSN, or some other information that can be correlated to the STSN value in the second transmitted segment 520.

According to some embodiments of the present invention, STSN and R-STSN fields may be placed in an extended TCP header through introduction of a new TCP option. In other embodiments of the present invention, potentially more efficient provision of segment transmission sequence numbers may be achieved by using existing segment header fields to support new functions. For example, a conventional TCP entity typically transmits data bytes in an ordered fashion, i.e., it typically buffers out of sequence data to assemble an ordered sequence for transmission. However, it may sometimes be desirable to transmit one or more bytes notwithstanding sequence. Accordingly, the conventional TCP segment header format typically includes an Urgent Pointer field and an associated control flag (URG) used to indicate the presence of and extent of urgent data in a segment. The URG and Urgent Pointer features may be used, for example, to deliver data (urgent data) in an out of sequence fashion.

In many applications, however, the urgent data delivery feature of TCP may be rarely used. According to some embodiments of the present invention, these rarely used fields may be used to convey segment transmission sequence numbers, thus obviating the need to create additional overhead to carry segment transmission sequence numbers.

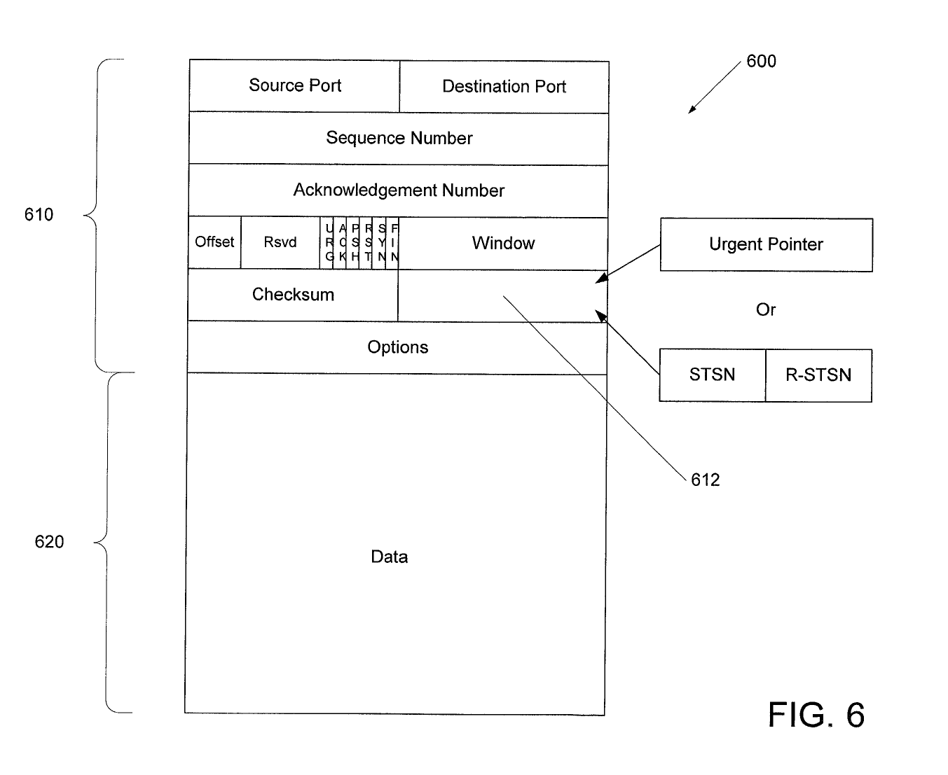

FIG. 6 illustrates a modified TCP segment format 600 according to such embodiments of the invention. The segment format 600 includes a header portion 610 and a data portion 620. The header portion 610 includes several fields as found in a conventional TCP segment, including:

Source Port—a 16-bit field used to identify the source of the segment 600;

Destination Port—a 16-bit field used to identify the destination of the segment 600;

Sequence Number—a 32-bit field used to indicate the sequence number of the first data byte in the data portion 620;

Acknowledgment Number—a 32-bit field used to indicate the value of the Sequence Number that the entity sending the segment 600 is expecting to receive next;

Data Offset—a field used to indicate the number of 32-bit words in the header portion 610;

Reserved—a 6-bit field reserved for future use;

URG—a field used to indicate presence of urgent (i.e., out of sequence) data in the data portion 620;

ACK—a field used to indicate that the Acknowledgment Number field is significant;

PSH—a field used to implement a push function;

RST—a field used to implement a reset function;

SYN—a field used to synchronize sequence numbers;

FIN—a field used to indicate an end of data;

Window—a field used to indicate a number of data bytes that the sender of the segment 600 is willing to accept;

Checksum—a field used to carry a checksum of a pseudo-header (including information regarding source and destination IP addresses), the segment header portion 610, and the data portion 620; and

Options—a variable-length field used to invoke TCP options.

According to embodiments of the present invention, the header portion 610 further includes a field 612 that is used, depending on contents of the data portion 620, to carry either an Urgent Pointer value (as in conventional TCP) or a combination of a segment transmission sequence number (STSN) and a reflected (acknowledging) segment transmission sequence number (R-STSN). The URG field of the segment format 600 may be used to signal whether the field 612 includes an Urgent Pointer value or segment transmission sequence numbers. In particular, when urgent data is present in the segment 600, its URG value can be set to 1, indicating that the field 612 includes an Urgent Pointer value. If no urgent data is present, however, the URG field can be set to 0, and the field 612 may be used to carry one or more segment transmission sequence numbers for use in determining a round trip time or for other purposes. An entity receiving such a segment can process information in the header of the segment based on the value in the URG field.

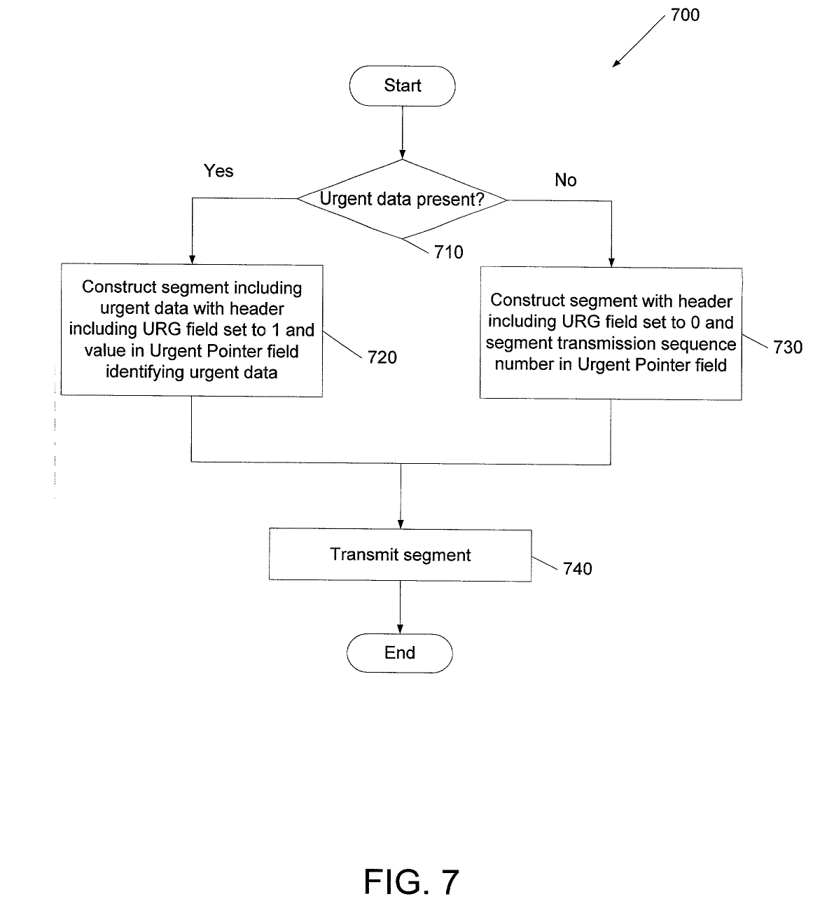

FIG. 7 illustrates exemplary sending entity operations 700 for using an Urgent Pointer field in such a fashion according to embodiments of the present invention. An entity determines whether urgent data is to be transmitted (Block 710). If so, the entity constructs a segment including urgent data in its data portion and a header including an URG value of 1 and an Urgent Pointer value in its Urgent Pointer field (Block 720). If no urgent data is present, however, the entity constructs the segment such that its URG field is 0 and its Urgent Pointer field includes segment transmission sequence numbers (Block 730). The appropriately constructed segment is then transmitted from the entity (Block 740).

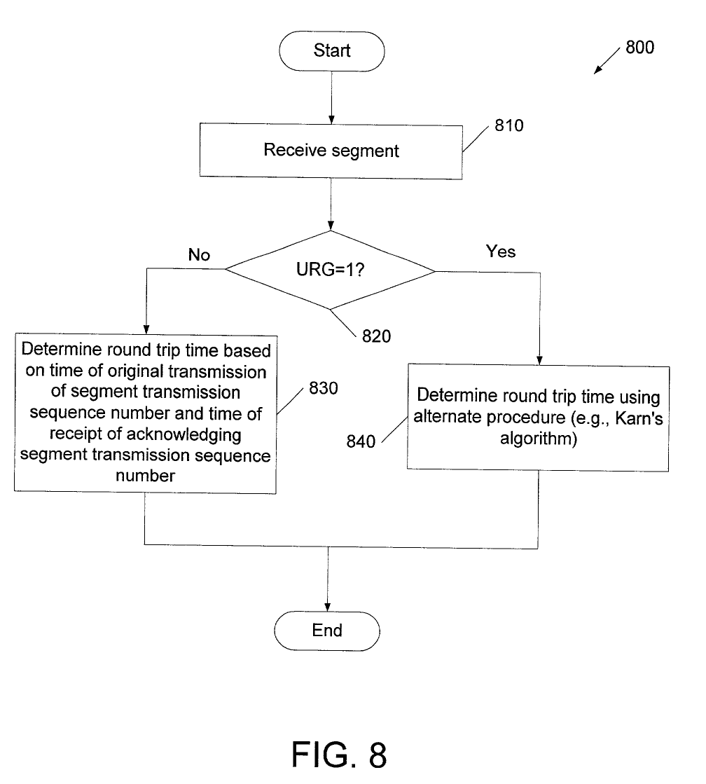

FIG. 8 illustrates exemplary receiving entity operations 800 for segments constructed as shown in FIG. 7. A segment is received (Block 810) and is examined to determine the value in its URG field (Block 820). If URG=0, indicating an absence of urgent data, the receiving entity can determine round trip time by examining the acknowledge segment transmission sequence number in the Urgent Pointer field of the received message (Block 830). However, if URG=1, indicating the presence of urgent data, the receiving entity may ignore the value in the Urgent Pointer field for purposes of determining a round trip time. For example, the receiving entity may defer round trip measurements based on this segment. Alternatively, as shown in FIG. 8, the receiving entity may use an alternate round trip time estimation procedure, such as Karn's algorithm (Block 840).

In the drawings and specification, there have been disclosed typical embodiments of the invention and, although specific terms are employed, they are used in a generic and descriptive sense only and not for purposes of limitation, the scope of the invention being set forth in the following claims.

What which is claimed is:

1. A method of operating an entity of a communications system, the entity operative to communicate with at least one other entity of the communications system via a communications medium, the method comprising:
transmitting a segment from the entity, the segment conforming to a segment format comprising a data portion and a header portion comprising a field for a sequence number associated with data in the data portion, wherein the header portion of the transmitted segment includes a segment transmission sequence number.

2. A method according to claim 1, wherein, according to the segment format, the field for a sequence number associated with data in the data portion comprises a field for a sequence number of a data byte in the data portion.

3. A method according to claim 1, wherein the header portion of the segment format further comprises an Urgent Pointer field, and wherein the Urgent Pointer field of the header portion of the transmitted segment includes the segment transmission sequence number.

4. A method according to claim 3, further comprising including the segment transmission sequence number in the Urgent Pointer field of the header of the transmitted segment responsive to an absence of urgent data in the data portion of the transmitted segment.

5. A method according to claim 1:
wherein transmitting a segment from the entity comprises transmitting a first segment from the entity, the first segment conforming to the segment format and comprising a segment transmission sequence number in a predefined field of its header portion; and
wherein the method further comprises transmitting a second segment from the entity, the second segment conforming to the segment format and comprising information other than a segment transmission sequence number in the predefined field of its header portion.

6. A method according to claim 1:
wherein the header portion of the segment format further comprises an Urgent Pointer field;
wherein transmitting a segment from the entity comprises transmitting a first segment from the entity, the first segment conforming to the segment format and comprising a header portion comprising a first segment transmission sequence number in its Urgent Pointer field; and
wherein the method further comprises transmitting a second segment from the entity, the second segment conforming to the segment format and comprising a second header portion comprising a value in its Urgent Pointer field that identifies urgent data in a data portion of the second segment.

7. A method according to claim 1, further comprising:
receiving an acknowledgment of the transmitted segment at the entity; and
determining a round trip time responsive to the transmission of the segment and the receipt of the acknowledgment.

8. A method according to claim 7:
wherein transmitting a segment from the entity comprises transmitting a first segment from the entity, the first segment conforming to the segment format and comprising a first segment transmission sequence number in its header portion;
wherein receiving an acknowledgment at the entity comprises receiving a second segment at the entity, the second segment conforming to the segment format and comprising a segment transmission sequence number in its header portion; and
wherein determining a round trip time responsive to the transmission of the segment and the receipt of the acknowledgment comprises determining the round trip time responsive to the transmission of the first segment and the receipt of the second segment.

9. A method according to claim 8, further comprising:
determining a time of transmission of the first segment;
determining a time of reception of the second segment; and
wherein determining the round trip time responsive to the transmission of the first segment and the receipt of the second segment comprises determining the round trip time from the determined time of transmission and the determined time of reception.

10. A method according to claim 7, further comprising adjusting a retransmission timing based on the determined round trip time.

11. A method according to claim 1:
receiving a first segment at the entity, the first segment conforming to the segment format and comprising a segment transmission sequence number in a predefined field of its header portion;
receiving a second segment at the entity, the second segment conforming to the segment format and comprising information other than a segment transmission sequence number in the predefined field of its header portion;
determining a round trip time according to a first procedure responsive to receipt of the first segment; and
determining a round trip time according to a second procedure responsive to the receipt of the second segment.

12. A method according to claim 1, wherein transmitting a segment from the entity comprises transmitting the segment in one of a wireless communications medium, a wireline communications medium, and an optical communications medium.

13. A method of operating an entity of a communications system, the entity operative to communicate with at least one other entity of the communications system via a communications medium, the method comprising:
receiving a segment at the entity, the segment conforming to a segment format comprising a data portion and a header portion comprising a field for a sequence number associated with data in the data portion, wherein the header portion of the received segment includes a segment transmission sequence number; and
transmitting an acknowledgment reflecting the segment transmission sequence number of the received segment from the entity.

14. A method according to claim 13, wherein transmitting an acknowledgment reflecting the segment transmission sequence number of the received segment from the entity comprises transmitting a segment conforming to the segment format and including a segment transmission sequence number in its header portion.

15. A method according to claim 14, wherein the transmitted segment includes the same segment transmission sequence number as the received segment.

16. A method according to claim 13, wherein, according to the segment format, the field for a sequence number associated with data in the data portion comprises a field for a sequence number of a data byte in the data portion.

17. A method according to claim 13, wherein the header portion of the segment format further comprises an Urgent Pointer field, and wherein the Urgent Pointer field of the header portion of the received segment includes the segment transmission sequence number.

18. A method according to claim 13, wherein receiving a segment at the entity comprises receiving the segment from one of a wireless communications medium, a wireline communications medium and an optical communication medium, and transmitting an acknowledgment reflecting the segment transmission sequence number of the received segment from the entity comprises transmitting the acknowledgment in the one of the wireless communications medium, the wireline communications medium and the optical communications medium.

19. A method of formatting TCP segments, the method comprising:
including segment transmission sequence numbers in header portions of the segments.

20. A method according to claim 19, wherein including segment transmission sequence numbers in header portions of the segments comprises including segment transmission sequence numbers in predefined field of header portions of first segments and including information other than segment transmission sequence numbers in the predefined fields of header portions of second segments.

21. A method according to claim 20, further comprising determining a round trip time according to respective first and second different procedures responsive to receipt of the first and second segments.

22. A method according to claim 20, wherein including segment transmission sequence numbers in header portions of the segments comprises including a segment transmission sequence number in an Urgent Pointer field of a segment.

23. A method according to claim 22, wherein including a segment transmission sequence number in an Urgent Pointer field of a segment comprises including a segment transmission sequence number in an Urgent Pointer field of the segment responsive to an absence of urgent data.

24. A method according to claim 19, further comprising determining a round trip time responsive to receipt of a segment transmission sequence number.

25. A method according to claim 24, further comprising adjusting a retransmission timing based on the determined round trip time.

26. A communications data structure embodied in a physical medium, the communications data structure comprising:
a segment comprising a data portion and a header portion comprising a field for a sequence number associated with data in the data portion, wherein the header portion of the segment includes a segment transmission sequence number.

27. A communications data structure according to claim 26, wherein the header portion of the segment further comprises an Urgent Pointer field including the segment transmission sequence number.

28. A communications data structure according to claim 26, embodied in one of a wireless communications medium, a wireline communications medium, an optical communications medium, and a storage medium.

29. An apparatus, comprising:
a circuit configured to construct a segment conforming to a segment format comprising a data portion and a header portion comprising a field for a sequence number associated with data in the data portion, wherein the header portion of the segment includes a segment transmission sequence number.

30. An apparatus according to claim 29, wherein, according to the segment format, the field for a sequence number associated with data in the data portion comprises a field for a sequence number of a data byte in the data portion.

31. An apparatus according to claim 29, wherein the header portion of the segment format further comprises an Urgent Pointer field, and wherein the Urgent Pointer field of the header portion of the segment includes the segment transmission sequence number.

32. An apparatus according to claim 31, wherein the circuit is further operative to include the segment transmission sequence number in the Urgent Pointer field of the header of the segment responsive to an absence of urgent data in the data portion of the segment.

33. An apparatus according to claim 29, wherein the circuit is operative to construct a first segment conforming to the segment format and comprising a segment transmission sequence number in a predefined field of its header and to construct a second segment conforming to the segment format and comprising information other than a segment transmission sequence number in the predefined field of its header.

34. An apparatus according to claim 29:
wherein the header portion of the segment format further comprises an Urgent Pointer field;
wherein the circuit is operative to construct a first segment conforming to the segment format and comprising a first header portion comprising a first segment transmission sequence number in its Urgent Pointer field and to construct a second segment conforming to the segment format and comprising a second header portion comprising a value in its Urgent Pointer field that identifies urgent data in a data portion of the second segment.

35. An apparatus according to claim 29, wherein the circuit is further operative to receive an acknowledgment reflecting the segment transmission sequence number of the constructed segment and to determine a round trip time responsive to receipt of the acknowledgment.

36. An apparatus according to claim 35, wherein the circuit is operative to receive a segment conforming to the segment format and comprising a segment transmission sequence number in its header portion, and to determine the round trip time responsive to receipt of the segment.

37. An apparatus according to claim 35, wherein the circuit is further operative to adjust a retransmission timing based on the determined round trip time.

38. An apparatus according to claim 35, wherein the circuit is operative to receive a first segment conforming to the segment format and comprising a segment transmission sequence number in a predefined field of its header portion and to receive a second segment conforming to the segment format and comprising information other than a segment transmission sequence number in the predefined field of its header portion and to determine round trip time according to respective first and second procedures responsive to receipt of respective ones of the first and second segments.

39. An apparatus according to claim 29, wherein the constructed segment comprises first and second sequence numbers in its header portion.

40. An apparatus according to claim 39, wherein the header portion of the segment format further comprises an Urgent Pointer field, and wherein the first and second segment transmission sequence numbers are included in the Urgent Pointer field of the header portion of the constructed segment.

41. An apparatus according to claim 29, wherein the circuit is operative to transmit the segment in one of a wireless communications medium, a wireline communications medium, and an optical communications medium.

42. An apparatus, comprising:
a circuit configured to receive a segment conforming to a segment format comprising a data portion and a header portion comprising a field for a sequence number associated with data in the data portion, the header portion of the received segment including a segment transmission sequence number and to responsively construct an acknowledgment reflecting the segment transmission sequence number of the received segment.

43. An apparatus according to claim 42, wherein, according to the segment format, the field for a sequence number associated with data in the data portion comprises a field for a sequence number of a data byte in the data portion.

44. An apparatus according to claim 42, wherein the header portion of the segment format further comprises an Urgent Pointer field, and wherein the Urgent Pointer field of the header portion of the received segment includes the segment transmission sequence number.

45. An apparatus according to claim 42, wherein the circuit is operative to receive the segment from one of a wireless communications medium, a wireline communications medium and an optical communication medium and to transmit the acknowledgment in the one of the wireless communications medium, the wireline communications medium and the optical communications medium.

46. A computer program product for creating data structures for transmission in a communications system, the computer program product comprising computer-readable program code embodied in a computer-readable storage medium, the computer-readable program code comprising:
program code for constructing a segment conforming to a segment format comprising a data portion and a header portion comprising a field for a sequence number associated with data in the data portion, wherein the header portion of the segment includes a segment transmission sequence number.

47. A computer program product according to claim 46, wherein, according to the segment format, the field for a sequence number associated with data in the data portion comprises a field for a sequence number of a data byte in the data portion.

48. A computer program product according to claim 46, wherein the header portion of the segment format further comprises an Urgent Pointer field, and wherein the Urgent Pointer field of the header portion of the transmitted segment includes the segment transmission sequence number.

49. A computer program product according to claim 48, wherein the computer-readable program code further comprises program code for including the segment transmission sequence number in the Urgent Pointer field of the header of the segment responsive to an absence of urgent data in the data portion of the segment.

50. A computer program product according to claim 46:
wherein the program code for constructing a segment comprises program code for constructing a first segment conforming to the segment format and comprising a segment transmission sequence number in a predefined field of its header portion; and
wherein the computer-readable program code further comprises program code for constructing a second segment conforming to the segment format and comprising information other than a segment transmission sequence number in the predefined field of its header portion.

51. A computer program product according to claim 46, wherein the computer-readable program code further comprises:
program code for determining a time of transmission for the constructed segment;
program code for determining a reception time of an acknowledgment of the constructed segment; and
program code for determining a round trip time based on the determined transmission and reception times.

52. A computer program product according to claim 51, wherein the computer-readable program code further comprises program code for adjusting a retransmission timing based on the determined round trip time.

53. A computer program product according to claim 46, wherein the computer-readable program code comprises:
program code for receiving a first segment, the first segment conforming to the segment format and comprising a segment transmission sequence number in a predefined field of its header portion;
program code for receiving a second segment, the second segment conforming to the segment format and comprising information other than a segment transmission sequence number in the predefined field of its header portion;
program code for determining a round trip time according to a first procedure responsive to receipt of the first segment; and
program code for determining a round trip time according to a second procedure responsive to the receipt of the second segment.

54. A computer program product for processing data structures in a communications system, the computer program product comprising computer-readable program code embodied in a computer-readable storage medium, the computer-readable program code comprising:
program code for receiving a segment conforming to a segment format comprising a data portion and a header portion comprising a field for a sequence number associated with data in the data portion, wherein the header portion of the received segment includes a segment transmission sequence number; and
program code for constructing an acknowledgment that reflects the segment transmission sequence number.

55. A computer program product according to claim 54, wherein, according to the segment format, the field for a sequence number associated with data in the data portion comprises a field for a sequence number of a data byte in the data portion.

56. A computer program product according to claim 54, wherein the header portion of the segment format further comprises an Urgent Pointer field, and wherein the Urgent Pointer field of the header portion of the received segment includes the segment transmission sequence number.

57. A computer program product according to claim 54, wherein the acknowledgment comprises a segment including first and second segment transmission sequence numbers in its header portion.
